(19) United States
(12) Patent Application Publication
(10) Pub. No.: US 2017/0058626 A1
(43) Pub. Date: Mar. 2, 2017

(54) Blowout Preventer with High-Temperature Pipe Ram Assembly

(71) Applicant: Cameron International Corporation, Houston, TX (US)

(72) Inventors: Raul Araujo, Cypress, TX (US); Jeff Lambert, Tomball, TX (US)

(73) Assignee: Cameron International Corporation, Houston, TX (US)

(21) Appl. No.: 14/842,898

(22) Filed: Sep. 2, 2015

(51) Int. Cl. E21B 33/06; B29C 45/73; B29C 45/14

(52) U.S. Cl. CPC E21B 33/062; B29C 45/14008; B29C 45/73; B29K 2021/00

(57) ABSTRACT

A pipe ram blowout preventer (“BOP”) may be used for sealing about an object positioned in a vertical bore extending through the BOP. The BOP includes a pipe ram assembly movable towards the tubular, the pipe ram assembly including a packer assembly comprising an elastomeric body for sealing against the object. The packer assembly includes a packer insert within the elastomeric body, the packer insert comprising a generally interlaced structure, such as a wire mesh. The packer insert reduces deleterious effects of using a pipe ram assembly in high temperature environments by resisting crumbling of the elastomeric material when it becomes brittle.

### BACKGROUND

This section is intended to introduce the reader to various aspects of art that may be related to various aspects of the presently described embodiments. This discussion is believed to be helpful in providing the reader with background information to facilitate a better understanding of the various aspects of the present embodiments. Accordingly, it should be understood that these statements are to be read in this light, and not as admissions of prior art.

Blowout preventers (BOPs) are used extensively throughout the oil and gas industry. Typical BOPs are used as a large specialized valve or similar mechanical device that seal, control, and monitor oil and gas wells. The two categories of BOPs that are most prevalent are ram BOPs and annular BOPs. Blowout preventer stacks frequently utilize both types of BOPs, typically with at least one annular BOP stacked above several ram BOPs. The ram units in ram BOPs allow for shearing drill pipe in the case of shear rams, and sealing off around drill pipe in the case of pipe rams. Typically, a BOP stack may be secured to a wellhead and may provide a safe means for sealing the well in the event of a system failure.

An example BOP includes a main body or housing with a vertical bore. Ram bonnet assemblies may be bolted to opposing sides of the main body using a number of high tensile fasteners, such as bolts or studs. These fasteners are required to hold the bonnet in position to enable the sealing arrangements to work effectively. An elastomeric sealing element may be used between the ram bonnet and the main body. There are several configurations, but essentially they are all directed to preventing a leakage bypass between the mating faces of the ram bonnet and the main body. Each bonnet assembly includes a piston which is laterally movable within a ram cavity of the bonnet assembly by pressurized hydraulic fluid acting on one side of the piston. The opposite side of each piston has a connecting rod attached thereto which in turn has a ram mounted thereon. The rams can be shear rams for shearing an object within the bore of a BOP. Alternatively, the rams can be pipe rams for sealing off around an object within the bore of a BOP, such as a pipe, thereby sealing the annular space between the object and the BOP bore.

The rams are designed to move laterally toward the vertical bore of the BOP to shear or seal off on any object located therein. For instance, opposing pipe rams utilize seals that close in on and seal off on a tubular within the vertical bore of the BOP, such as a section of drill pipe used during drilling operations. Each pipe ram typically has a semicircular opening in its front face to form a seal about half of the outer periphery of the object within the BOP vertical bore. When the opposing pipe rams are closed, the opposing pipe rams engage each other and seal the entire periphery of the object, thereby closing off the annulus between the object and the BOP bore. Typical pipe ram assemblies can include a ram packer which is composed of an elastomeric or rubber material configured to seal off against the tubular within the vertical bore of the BOP when the opposing rams are run into the closed position.

Ram packers are susceptible to mechanical wear, particularly at high temperature. For instance, at 400° F. (204.44° C.), the elastomeric or rubber material of a ram packer can become brittle, causing pieces of the material to separate from and fall off of the ram packer assembly. In addition, the ram packer material can crack at high temperature. Both issues result in the ram packer losing its sealing capability around the tubular.

Accordingly, a pipe ram packer assembly that is suitable for sealing off on an object in a bore of a BOP is desirable, particularly at high temperature. More particularly, a pipe ram packer assembly that resists losing packer material at high temperatures is desirable.

### DESCRIPTION OF THE DRAWINGS

For a detailed description of the preferred embodiments of the present disclosure, reference will now be made to the accompanying drawings in which:

FIG. 1 is a sectional view of a pipe ram BOP;

FIG. 2 is a perspective view of a ram assembly including a packer assembly;

FIG. 3 is a perspective view of packer assembly including an elastomeric body located therein;

FIG. 4 is a perspective view of packer assembly including a packer insert; and

FIG. 5 is a perspective view of packer insert.

### DETAILED DESCRIPTION

The following discussion is directed to various embodiments of the present disclosure. The drawing figures are not necessarily to scale. Certain features of the embodiments may be shown exaggerated in scale or in somewhat schematic form and some details of conventional elements may not be shown in the interest of clarity and conciseness. Although one or more of these embodiments may be preferred, the embodiments disclosed should not be interpreted, or otherwise used, as limiting the scope of the disclosure, including the claims. It is to be fully recognized that the different teachings of the embodiments discussed below may be employed separately or in any suitable combination to produce desired results. In addition, one skilled in the art will understand that the following description has broad application, and the discussion of any embodiment is meant only to be exemplary of that embodiment, and not intended to intimate that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but are the same structure or function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. In addition, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis. The use of “top,” “bottom,” “above,” “below,” and variations of these terms is made for convenience, but does not require any particular orientation of the components.

Reference throughout this specification to “one embodiment,” “an embodiment,” or similar language means that a particular feature, structure, or characteristic described in connection with the embodiment may be included in at least one embodiment of the present disclosure. Thus, appearances of the phrases “in one embodiment,” “in an embodiment,” and similar language throughout this specification may, but do not necessarily, all refer to the same embodiment.

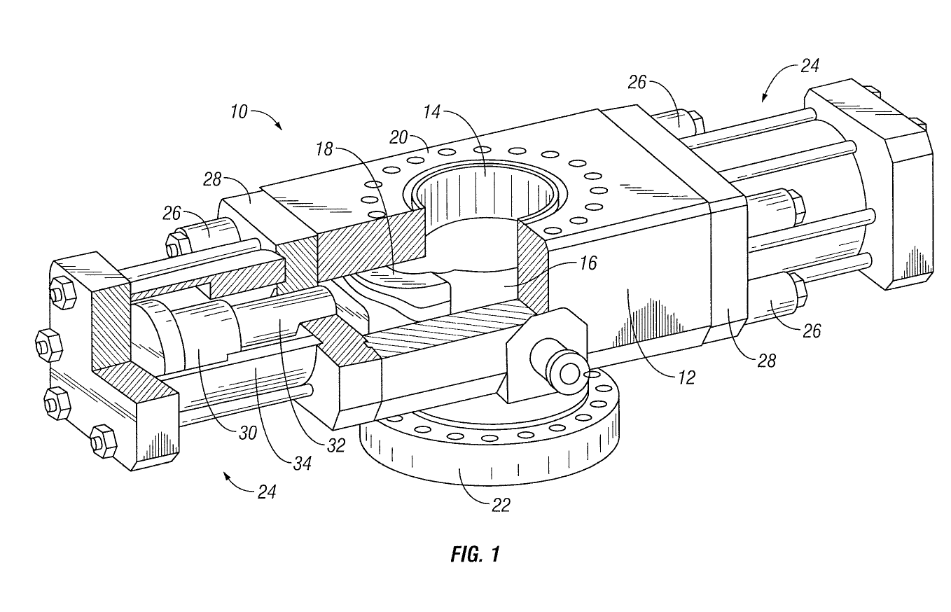

Referring now to FIG. 1, a sectional view of a pipe ram BOP 10 is shown for illustrative purposes. The BOP 10 includes a housing 12, such as a hollow body, with a vertical bore 14 that enables passage of fluid or an object, such as a tubular member, through the BOP 10. The housing 12 further includes one or more cavities, such as ram cavities 16 opposed from each other with respect to the vertical bore 14, with a pipe ram assembly 18 movably positioned within each cavity 16. The BOP 10 may be coupled to other equipment that facilitates natural resource production. For instance, production equipment or other components may be attached to the top of the BOP 10 using a connection 20 (which may be facilitated in the form of fasteners), and the BOP 10 may be attached to a wellhead or spool using the flange 22 and additional fasteners.

One or more bonnet assemblies 24 are secured to the housing 12 and include various components that facilitate control of the ram assemblies 18 positioned in the BOP 10. The bonnet assemblies 24 are coupled to the housing 12 by using one or more fasteners 26 to secure the bonnets 28 of the bonnet assemblies 24 to the housing 12. The ram assemblies 18 are then actuated and moved through the cavities 16, into and out of the bore 14, by operating and moving a piston 30 and a rod 32 coupled thereto within a housing 34 of the bonnet assemblies 24.

In operation, a force (e.g., from hydraulic pressure) may be applied to the pistons 30 to drive the rods 32, which in turn drives the rams 18 coupled thereto into the bore 14 of the BOP 10. The ram assemblies 18 cooperate with one another when driven together to seal the bore 14 and inhibit flow through the BOP 10.

In this embodiment, a hydraulic actuator is shown, though any type of actuator (e.g., pneumatic, electrical, mechanical) may be used in accordance with the present disclosure. As such, this embodiment may include a piston 30 and a rod 32 connecting the piston 30 to ram assembly 18. Further, pressurized fluid may be introduced and fluidly communicated on opposite sides of the piston 30 thereby enabling the piston 30 to move the ram assembly 18 in response to fluid pressure.

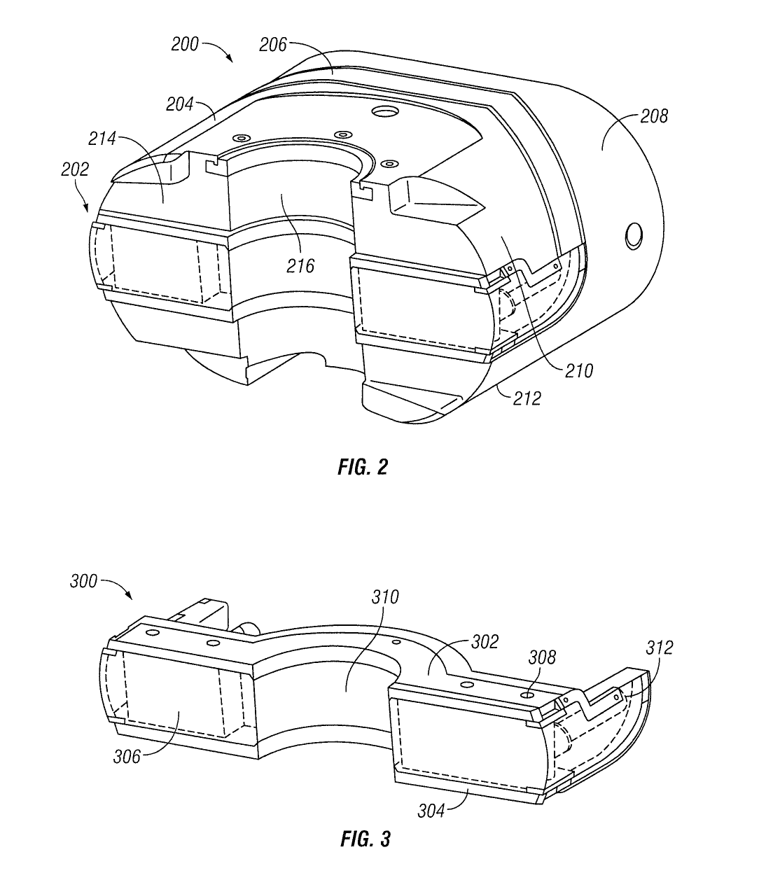

Turning now to FIG. 2, a ram assembly 200 including a packer assembly 202 is shown for illustrative purposes. Ram assembly 200 is similar to ram assembly 18 illustrated in FIG. 1. Ram assembly 200 includes a ram body 204, top seal 206, and packer assembly 202. Ram body 204 is a generally rectangular parallelepiped shape with rounded sides 208 that fit in laterally disposed ram cavities of a BOP, such as ram cavities 16 illustrated in FIG. 1.

Ram body 204 includes an upper body 210 and a lower body 212 connected by front face 214 and defining a packer assembly cavity therebetween. In the illustrated embodiment, packer assembly 202 is inserted within the packer assembly cavity. Formed within front face 214 of upper body 210 is ram bore profile 216. Ram bore profile 216 is substantially semi-circularly shaped and extends vertically through upper body 210 and lower body 212 to packer assembly 202.

Turning now to FIG. 3, a packer assembly 300 is shown for illustrative purposes. Packer assembly 300 is similar to packer assembly 202 illustrated in FIG. 2. Packer assembly 300 includes an upper plate 302 and a lower plate 304. Packer assembly body 306 is molded in a semi-elliptical shape and positioned between upper plate 302 and lower plate 304. Body 306 can be molded in any desired shape, such as semi-elliptical, elliptical, circular, etc.

Body 306 is fastened to upper plate 302 via fasteners 308, such as screws or bolts. Body 306 is likewise coupled to lower plate 304 via fasteners, which are not shown in this illustration. In the illustrated embodiment, four fasteners 308 are shown. However, any number of fasteners may be used to secure body 306 to upper plate 302 and lower plate 304. A packer bore profile 310 is formed through upper plate 302, lower plate 304, and body 306. Body 306 is configured to be coupled to a ram assembly, such as ram assembly 200 illustrated in FIG. 2, by way of fasteners 312. One fastener 312 is positioned on each side of body 306 and configured to couple body 306 to a ram assembly. However, any number of fasteners 312 may be used.

Packer assembly body 306 is constructed of an elastomeric material, such as any synthetic or natural rubber. Body 306 is configured to seal about an object located within a vertical bore of a BOP when packer assembly 300 is moved to a closed position. In particular, body 306 is configured to seal about 180° of the object to be sealed upon. A corresponding packer assembly body in a corresponding packer assembly closes on the object from the opposing side and seals about the other 180° of the object. Exemplary objects to be sealed upon include a drill pipe joint, a casing joint, and a tool joint. In this way, packer assembly 300, together with a corresponding and opposing packer assembly run from an opposing side, provides for a fluid seal in the annular region between an object in a BOP borehole and the BOP housing. Packer assembly body 306 may include one or more inserts within body 306 to enhance the sealing ability of elastomer 306.

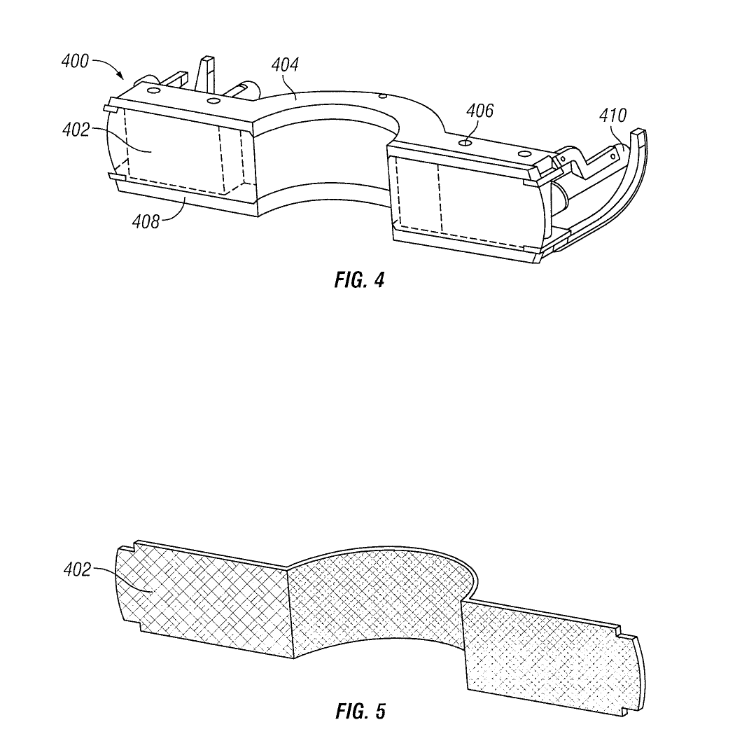

Turning now to FIGS. 4 and 5, packer assembly 400 is shown, for illustrative purposes, with the elastomer removed, thereby revealing packer insert 402. Packer insert 402 is fastened to upper plate 404 via fasteners 406, such as screws or bolts. Packer insert 402 is likewise coupled to lower plate 408 via fasteners, which are not shown in this illustration. In the illustrated embodiment, four fasteners 406 are shown. However, any number of fasteners may be used to secure packer insert 402 to upper plate 404 and lower plate 408. Further, packer insert 402 is configured to be coupled to a ram assembly, such as ram assembly 200 illustrated in FIG. 2, by way of fasteners 410. One fastener 410 is positioned on each side of packer insert 402 and configured to couple packer insert 402 to a ram assembly. However, any number of fasteners 410 may be used. Packer insert 402 is positioned inside the body 306 adjacent to the curved inner surface of the packer assembly, i.e., near the packer bore profile 310 illustrated in FIG. 3, and follows the contour of upper plate 404 and lower plate 408.

Packer insert 402 is a generally interlaced structure, such as a wire mesh. The degree of interlacing, i.e., the number of horizontal and vertical lattices and the spacing of same, can vary depending on the size of packer assembly 400 and on other design considerations, such as anticipated operating temperature, etc. Packer insert can be constructed of any desired material, such as steel, fiberglass, carbon fiber, and synthetic fiber. Packer insert 402 is incorporated into packer assembly 400 by molding the packer inset 402 into the packer assembly body, such as body 306 illustrated in FIG. 3. In particular, packer insert 402 is positioned in a mold which is in the desired shape of the packer body. Elastomeric material, such as a synthetic or nature rubber, is injected into the mold and cured or vulcanized in place. In this way, packer insert 402 is molded directly into the elastomeric body of the packer assembly.

Packer insert 402 is configured to resist elastomer deterioration and detachment, particularly at high temperatures, such as temperatures above about 350° F. (176.67° C.), particularly at temperatures above about 400° F. (204.44° C.). As discussed above, it is common for elastomeric inserts to become brittle at such high temperatures. When the elastomeric material becomes brittle, pieces of the elastomeric material will fall or crumble off of the packer assembly, particularly during closing operations. As a result, the sealing efficiency of the packer assembly diminishes. Packer insert 402 essentially functions as a barrier for the elastomeric body, preventing the elastomer material from crumbling off of the packer assembly when the elastomer becomes brittle. Packer insert 402 contains the elastomer material from falling off the packer assembly while still allowing the packer assembly to seal about an object in a BOP bore during closing operations.

Packer insert 402 is illustrated as having a generally rectangular profile. However, any other profile geometries are envisioned provided the packer insert can perform the functions discussed above, i.e., containing the elastomer material from falling off the packer assembly while still allowing the packer assembly to seal about an object in a BOP bore during closing operations. In addition, the illustrated embodiment generally shows packer insert 402 as following the contour of upper plate 404 and lower plate 408. However, packer insert 402 is not restricted to this position. For instance, the packer insert could be located only at the semicircular portion of the elastomeric insert, not spanning the entire face of the elastomer material.

Packer insert 402 can be incorporated into the packer assemblies of newly manufactured ram assemblies. Alternatively, packer insert 402 can be molded into a packer assembly and retrofitted to an existing ram assembly. In this way, older pipe ram assemblies can be retrofitted to extend the life of the ram assemblies and enable existing assemblies for use in higher temperature environments.

In addition to the embodiments described above, many examples of specific combinations are within the scope of the disclosure, some of which are detailed below:

### Example 1

A packer assembly for a pipe ram BOP configured to seal about an object located in a vertical bore of the BOP, the packer assembly comprising:
a body comprising an elastomeric material and a curved inner surface configured to engage the object; and
an insert comprising an interlaced structure locatable within the body and configured to diminish deterioration of the elastomeric material.

### Example 2

The packer assembly of Example 1, where the insert is configured to diminish deterioration of the elastomeric material during sealing operations at temperatures at or above about 400° F.

### Example 3

The packer assembly of Example 1, wherein the body is semi-elliptical in shape.

### Example 4

The packer assembly of Example 1, wherein the body is elliptical in shape.

### Example 5

The packer assembly of Example 1, wherein the insert is a wire mesh.

### Example 6

The packer assembly of Example 5, wherein the wire mesh comprises at least one of steel, fiberglass, carbon fiber, and synthetic fiber.

### Example 7

The packer assembly of Example 1, wherein the insert is positioned adjacent the curved inner surface.

### Example 8

The packer assembly of Example 1, wherein the elastomeric material is synthetic or natural rubber

### Example 9

The packer assembly of Example 1, wherein the object is one of a drill pipe joint, casing joint, or tool joint.

### Example 10

A BOP assembly comprising:
a body comprising a vertical bore extending through the body and a ram cavity intersecting the bore;
a hydraulically actuated pipe ram configured to seal about an object located in the vertical bore, the pipe ram comprising a packer assembly comprising:
   a packer body comprising an elastomeric material and a curved inner surface configured to engage the object; and
   an insert comprising an interlaced structure locatable within the packer body and configured to diminish deterioration of the elastomeric material.

### Example 11

The BOP assembly of Example 10, where the insert is configured to diminish deterioration of the elastomeric material during sealing operations at temperatures at or above about 400° F.

### Example 12

The BOP assembly of Example 10, wherein the packer body is semi-elliptical in shape.

### Example 13

The BOP assembly of Example 10, wherein the packer body is elliptical in shape.

### Example 14

The BOP assembly of Example 10, wherein the insert is a wire mesh.

### Example 15

The BOP assembly of Example 14, wherein the wire mesh comprises at least one of steel, fiberglass, carbon fiber, and synthetic fiber.

### Example 16

The BOP assembly of Example 10, wherein the insert is positioned adjacent the curved inner surface.

### Example 17

The BOP assembly of Example 10, wherein the elastomeric material is synthetic or natural rubber

### Example 18

The BOP assembly of Example 10, wherein the object is one of a drill pipe joint, casing joint, or tool joint.

### Example 19

The BOP assembly of Example 10, further comprising another an opposing hydraulically actuated pipe ram configured to seal about the object located in the vertical bore, the opposing pipe ram comprising a packer assembly comprising an insert including an interlaced structure.

### Example 20

A method of making a packer assembly for a pipe ram BOP, the method comprising:
providing a mold with desired dimensions for the packer assembly;
inserting a packer insert comprising an interlaced structure into the mold;
heating the mold and packer insert;
inject an elastomeric material into mold; and
curing/vulcanizing the elastomeric material to form the packer assembly.

While the aspects of the present disclosure may be susceptible to various modifications and alternative forms, specific embodiments have been shown by way of example in the drawings and have been described in detail herein. But it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A packer assembly for a pipe ram blowout preventer (“BOP”) configured to seal about an object located in a vertical bore of the BOP, the packer assembly comprising:
a body comprising:
an elastomeric material and a curved inner surface configured to engage the object; and
an insert comprising an interlaced structure locatable within the body and configured to diminish deterioration of the elastomeric material.

2. The packer assembly of claim 1, where the insert is configured to diminish deterioration of the elastomeric material during sealing operations at temperatures at or above about 400° F. (204.44° C.).

3. The packer assembly of claim 1, wherein the body is semi-elliptical in shape.

4. The packer assembly of claim 1, wherein the body is elliptical in shape.

5. The packer assembly of claim 1, wherein the insert comprises wire mesh.

6. The packer assembly of claim 5, wherein the wire mesh comprises at least one of steel, fiberglass, carbon fiber, and synthetic fiber.

7. The packer assembly of claim 1, wherein the insert is positioned adjacent the curved inner surface.

8. The packer assembly of claim 1, wherein the elastomeric material is synthetic or natural rubber

9. The packer assembly of claim 1, wherein the object is one of a drill pipe joint, casing joint, or tool joint.

10. A blowout preventer (“BOP”) assembly for sealing against an object, comprising:
a body comprising a vertical bore extending through the body and a ram cavity intersecting the bore;
a pipe ram configured to seal about the object when located in the vertical bore, the pipe ram comprising a packer assembly comprising:
a packer body comprising an elastomeric material and a curved inner surface configured to engage the object; and
an insert comprising an interlaced structure locatable within the packer body and configured to diminish deterioration of the elastomeric material.

11. The BOP assembly of claim 10, where the insert is configured to diminish deterioration of the elastomeric material during sealing operations at temperatures at or above about 400° F. (204.44° C.).

12. The BOP assembly of claim 10, wherein the packer body is semi-elliptical in shape.

13. The BOP assembly of claim 10, wherein the packer body is elliptical in shape.

14. The BOP assembly of claim 10, wherein the insert comprises wire mesh.

15. The BOP assembly of claim 14, wherein the wire mesh comprises at least one of steel, fiberglass, carbon fiber, and synthetic fiber.

16. The BOP assembly of claim 10, wherein the insert is positioned adjacent the curved inner surface.

17. The BOP assembly of claim 10, wherein the elastomeric material is synthetic or natural rubber

18. The BOP assembly of claim 10, wherein the object is one of a drill pipe joint, casing joint, or tool joint.

19. The BOP assembly of claim 10, further comprising another an opposing hydraulically actuated pipe ram configured to seal about the object located in the vertical bore, the opposing pipe ram comprising a packer assembly comprising an insert including an interlaced structure.

20. A method of making a packer assembly for a pipe ram blowout preventer, the method comprising:
providing a mold with desired dimensions for the packer assembly;
inserting a packer insert comprising an interlaced structure into the mold;
heating the mold and packer insert;
inject an elastomeric material into mold; and
curing the elastomeric material to form the packer assembly.
